(19) United States
(12) Patent Application Publication
(10) Pub. No.: US 2014/0217921 A1
(43) Pub. Date: Aug. 7, 2014

(54) LINEARLY DIMMING CIRCUIT OF LIGHT-EMITTING DEVICE AND METHOD THEREOF

(71) Applicant: RICHTEK TECHNOLOGY CORP., Hsinchu (TW)

(72) Inventors: Shei Chie Yang, Hsinchu (TW); Shui Mu Lin, Hsinchu (TW); Shih Chung Wang, Hsinchu (TW)

(21) Appl. No.: 13/914,667

(22) Filed: Jun. 11, 2013

(30) Foreign Application Priority Data
Feb. 1, 2013 (TW) 102104097

(51) Int. Cl. H05B 33/08

(52) U.S. Cl. CPC H05B 33/0812; H05B 33/0845
USPC 315/291

(57) ABSTRACT

A linearly dimming circuit of a light-emitting device, includes a diming signal processing unit, having a dimming signal input terminal and a current setting output terminal, wherein the dimming signal input terminal receives a luminance percentage setting to set a luminance of the light-emitting device to be a maximal luminance multiplying the luminance percentage setting, the dimming signal processing unit generates a current percentage setting according to the luminance percentage setting, the current setting output terminal outputs a driving current setting which sets the driving current to be a maximal driving current multiplying the current percentage setting; a light-emitting device driver stage, having a current setting input terminal and a driving current output terminal, wherein the current setting input terminal couples to the current setting output terminal and receives the driving current setting, the driving current output terminal outputs the driving current to the light-emitting device.

### CROSS-REFERENCES TO RELATED APPLICATIONS

This non-provisional application claims priority under 35 U.S.C. §119(a) on Patent Application No. 102104097 filed in Taiwan, R.O.C. on Feb. 1, 2013, the entire contents of which are hereby incorporated by reference.

### BACKGROUND

1. Technical Field

This disclosure relates to a linearly dimming circuit of a light-emitting device and a method thereof, especially to a linearly dimming circuit of a light-emitting device and a method thereof to derive a linear relation between an output luminance and an input control signal.

2. Description of Related Art

Generally, a light-emitting device, such as a light-emitting diode (LED), is driven by a driving current for emitting a light with a desired output luminance. The output luminance of the light-emitting device is controlled by the value of the driving current. There are two major methods for generating the driving current, that is the pulse-width-modulation (PWM) method and the direct-current (DC) method, both of which are generating an effective DC current corresponding to the desired output luminance.

The PWM method is often implemented by a high-frequency clock and a counter to decide a duty cycle of a pulse wave. Thus a good linearity between the generated output DC current and the input control signal for specifying the duty cycle can be derived, which is shown in FIG. 1. However the toggling of the pulse is prone to generate an electro-magnetic interference (EMI) with a specific frequency, which ranges from several hundred hertz to tens of kilo-hertz in a design in order to derive a good resolution on the change of the duty cycle for PWM method. However a sound with the above frequency range is audible for people, thus an audible noise is possibly generated in such a system.

On the other hand, the DC method generates a DC driving current directly to drive the light-emitting device, wherein a current mirror circuit is often adopted in design. However an issue of device matching in the current mirror circuit results in the inaccuracy of the output driving current, especially when the current value is small. Nonetheless the DC method can prevent from the audible noise problem mentioned above.

To compromise the above mentioned problems, a PWM/DC (mixed) method is adopted wherein the PWM method and the DC method are adopted in a design. First, a current threshold is defined in the mixed design. When the output current is larger than the current threshold, the DC method is adopted to output the driving current. Thus the audible noise is prevented, and the error of the output current is acceptable because the current value is relatively large. And when the output current is smaller than the current threshold, the PWM method is adopted to improve the accuracy of the smaller output current. Meanwhile the possible audible noise is alleviated because the output energy is relatively small for a smaller output current.

However for a practical light-emitting device, the output luminance and the driving current thereon is not perfectly linear. Even for the same output current setting, different output luminance is derived for different methods of generating output current, which is believed resulted from the different output current waveforms or different heat-dissipation effects. FIG. 2 shows the relation between the luminance of the light-emitting device (in nits) and the ratio of the output current to the maximal current for the light-emitting device. There are two curves in FIG. 2 corresponding to the PWM method and the DC method respectively. It can be observed that the DC method results in a larger error if a perfectly linear relation is desired. And though the PWM method is with a smaller error, a more accurate error requirement, like 1%, is not satisfied possibly.

### SUMMARY

In view of above problems, this disclosure provides a linearly dimming circuit of a light-emitting device and a method thereof to derive a linear relation between an output luminance and an input control signal.

In one or more embodiments, a linearly dimming circuit of a light-emitting device is adapted to output a driving current to drive the light-emitting device. The linearly dimming circuit of a light-emitting device includes a diming signal processing unit and a light-emitting device driver stage.

The diming signal processing unit has a dimming signal input terminal and a current setting output terminal. The dimming signal input terminal receives a luminance percentage setting to set a luminance of the light-emitting device to be a maximal luminance multiplying the luminance percentage setting. The dimming signal processing unit generates a current percentage setting according to the luminance percentage setting. The current setting output terminal outputs a driving current setting which sets the driving current to be a maximal driving current multiplying the current percentage setting.

The light-emitting device driver stage has a current setting input terminal and a driving current output terminal. The current setting input terminal couples to the current setting output terminal and receives the driving current setting. The driving current output terminal outputs the driving current to the light-emitting device.

And when the luminance percentage setting is larger than a luminance percentage threshold, the current percentage setting is either a quadratic function of the luminance percentage setting, or a solution of a quadratic equation wherein the constant term is the luminance percentage setting.

In another embodiment, a method for linearly dimming control of a light-emitting device includes the following steps.

First, input a luminance percentage setting.

Then, set the driving current to be a maximal driving current multiplying a current percentage setting, wherein the current percentage setting is a quadratic function of the luminance percentage setting.

Finally, a light-emitting device driver stage drives the light-emitting device with the driving current.

In yet another embodiment, a method for linearly dimming control of a light-emitting device includes the following steps.

First, input a luminance percentage setting.

Then, set the driving current to be a maximal driving current multiplying a current percentage setting, wherein the current percentage setting is a solution of a quadratic equation wherein the constant term is the luminance percentage setting.

Finally, a light-emitting device driver stage drives the light-emitting device with the driving current.

According to this disclosure, a simple function corresponding to the characteristics of a light-emitting device can be adopted to compensate the curve of the current percentage setting vs. the luminance percentage setting to derive the desired linear relation between the output luminance and the input control signal. And the coefficients of the mentioned simple function can all be adjusted flexibly such as by setting registers in a system. Thus the present disclosure has much flexibility on various applications.

These and other objectives of this disclosure will no doubt become obvious to those of ordinary skill in the art after reading the following detailed description of the preferred embodiments that is illustrated in the various figures and drawings.

### BRIEF DESCRIPTION OF THE DRAWINGS

FIG. 1 is a diagram of a curve of output DC current vs. duty cycle in dimming control with pulse-width-modulation in the art.

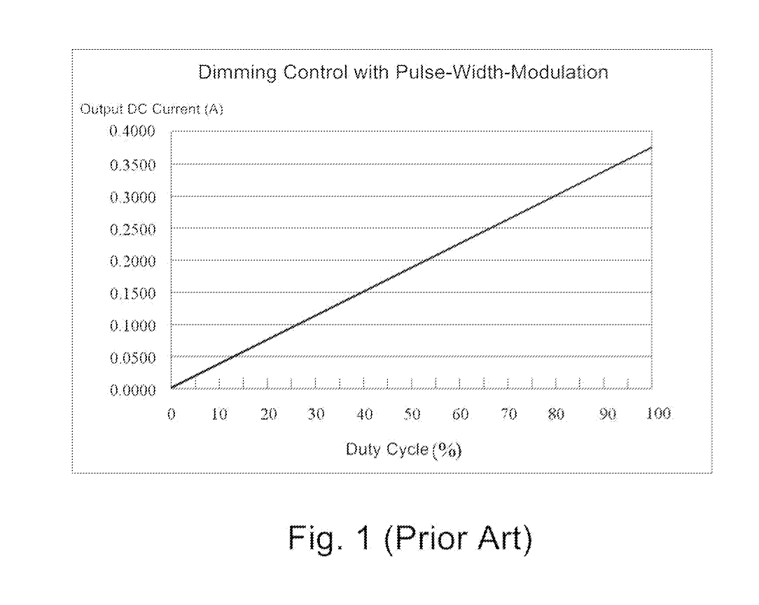

FIG. 2 is a diagram of curves of luminance of light-emitting device vs. ratio of output DC current to maximal current in various dimming control methods in the art.

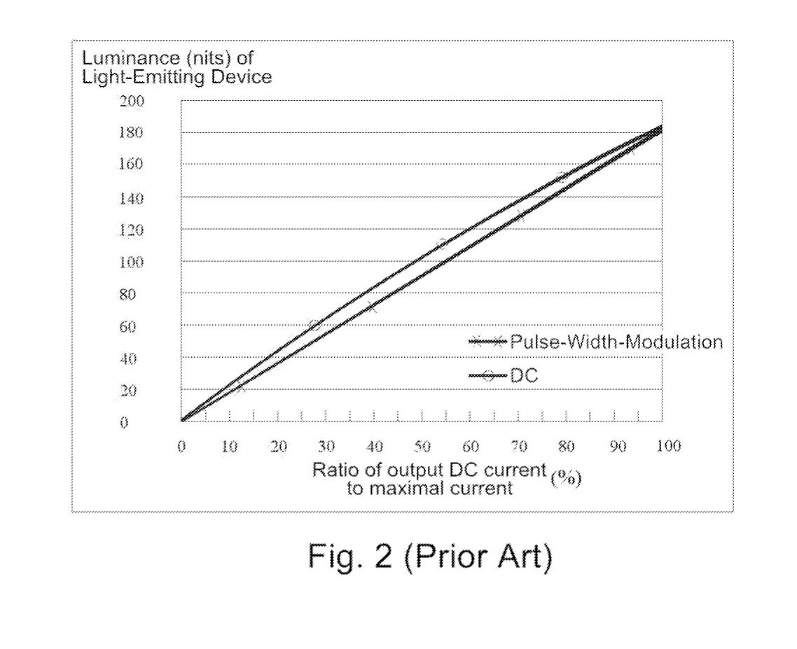

FIG. 3 is a diagram of curves of luminance error percentage vs. ratio of driving current setting to maximal current in various dimming control methods.

FIG. 4 is a diagram of real and approximated curves of luminance error percentage vs. ratio of driving current setting to maximal current.

FIG. 5 is a block diagram of a linearly dimming circuit of a light-emitting device of the present disclosure.

FIG. 6 is a flow chart of a first embodiment of a method for linearly dimming control of a light-emitting device of the present disclosure.

FIG. 7 is a flow chart of a second embodiment of a method for linearly dimming control of a light-emitting device of the present disclosure.

FIG. 8 is a flow chart of a third embodiment of a method for linearly dimming control of a light-emitting device of the present disclosure.

FIG. 9 is a flow chart of a fourth embodiment of a method for linearly dimming control of a light-emitting device of the present disclosure.

### DETAILED DESCRIPTION OF THE EMBODIMENTS

In an ideal condition, the relation of a luminance of a light-emitting device and a driving current thereon should be linear. That is, when the driving current is a specific percentage of a maximal driving current, the luminance should also be the specific percentage of a maximal luminance of the light-emitting device. However when a relation curve of a real light-emitting device is observed, error occurs compared to an ideal curve. Defining that the maximal luminance of the light-emitting device is L100%, a percentage of the driving current setting to the maximal driving current is Din which corresponds to a real luminance LDin and an ideal luminance L100%*Din, that is, Din is also the percentage ratio of the ideal luminance to the maximal luminance. Then a luminance error percentage R can be shown as equation (1):

$$R = \frac{{L}_{Din} - {L}_{100 \%} \cdot {D}_{in}}{{L}_{100 \%} \cdot {D}_{in}} . \qquad ( 1 )$$

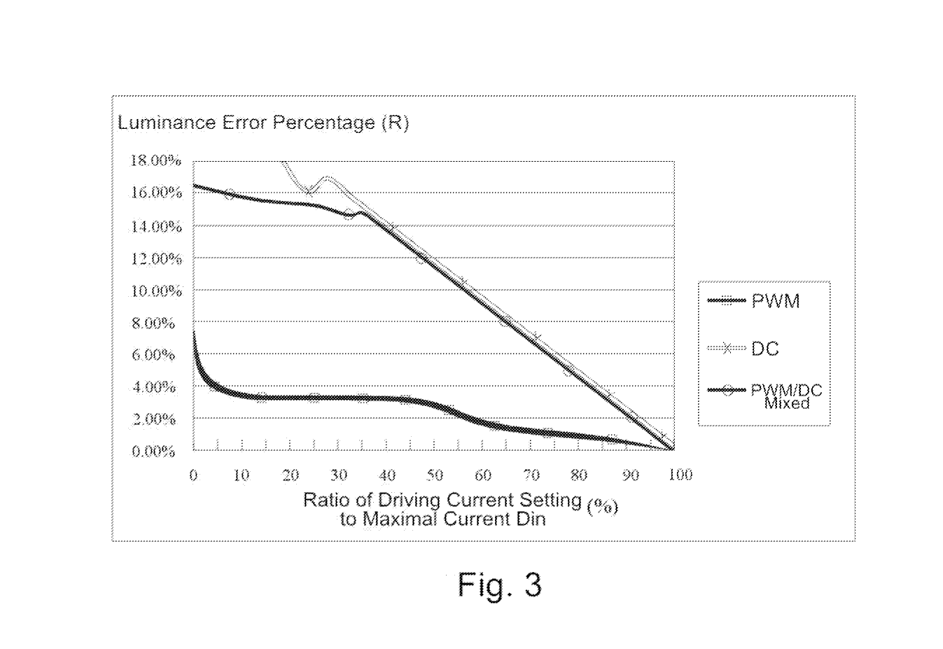

FIG. 3 is a diagram of curves of luminance error percentage R vs. Din, which is a percentage ratio of driving current setting to maximal current, in various dimming control methods. FIG. 3 is a result of real measurement, and the three curves therein correspond to dimming methods of a PWM, a DC, and a mixed method respectively. In the mixed method, a luminance percentage threshold is defined. When Din is larger than the luminance percentage threshold, the luminance error percentage R corresponds to that of the DC method. And when Din is smaller than the luminance percentage threshold, 25% of the maximal current is adopted to perform pulse-width-modulation dimming control, that is, the driving current toggles between the 25% of the maximal current and a zero current with a duty cycle determined by the PWM. Besides, the luminance percentage threshold can be stored in a register of a system adopting the present disclosure, and the register can be set according to various kinds of light-emitting devices.

For example when Din is 12.5%, the waveform of the driving current is a square wave wherein for 50% of one period the driving current is at 25% of the maximal current and for the other 50% of the same period the driving current is zero. Thus the effective DC current is 12.5% of the maximal current. As a result the luminance error percentage in this case is an integrated effect of the luminance error percentage R of the DC driving current at 25% and the error incurred by the PWM method. As shown in FIG. 3, it can be observed that the slope of the luminance error percentage of the mixed method when Din is smaller than 25% is roughly corresponding to the slope of the luminance error percentage of the pulse-width-modulation method.

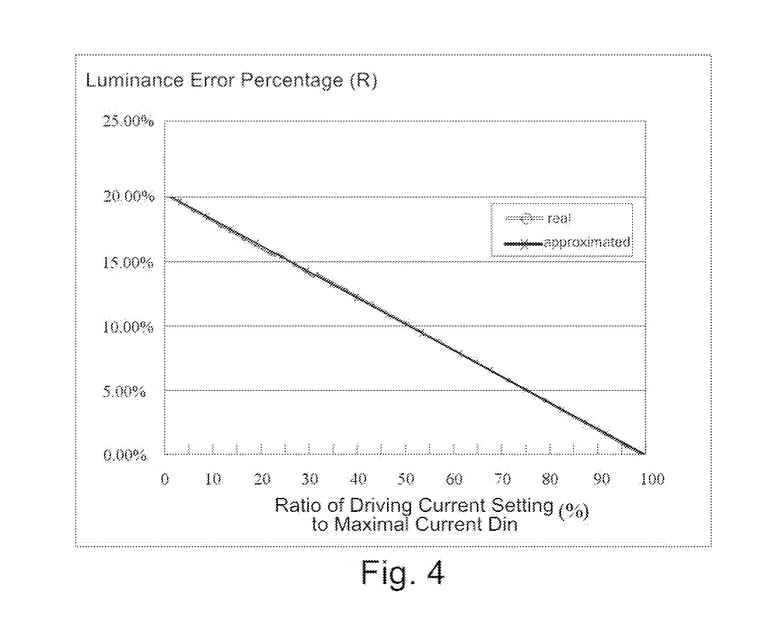

In more detail, as shown in FIG. 3, the curves of the luminance error percentage of the PWM method and the DC method can be approximated by two linear lines respectively. And on the lines the luminance error percentage are at 0% when Din is at 100%. In the present disclosure, the linearly dimming circuit and the method for linearly dimming control approximates the luminance error percentage R with a function to accordingly amend the luminance of the light-emitting device and restore the linear relation between the output luminance and the input control signal as possible as it can. FIG. 4 is a diagram of real and approximated curves of the luminance error percentage R vs. Din. The approximated curve can be represented as equation (2) as followed:

R(Dᵢₙ)=(1−Dᵢₙ)·K (2),

wherein K is a constant which is an absolute value of a slope of the approximated curve. And as mentioned before, in equation (2) when Din is 100%, the luminance error percentage R(100%) is 0%.

When the input control signal is Din, for the most part it means that the desired output luminance LDnew is L100% multiplying Din. However the real output luminance is LDin which is different from LDnew. The present disclosure adopts a simple function to derive a control signal Dnew corresponding to the desired output luminance LDnew and set the driving current to the light-emitting device accordingly. From the description in this paragraph and equation (1), equation (3) and equation (4) can be derived as followed:

L_{Din}=L_{100%}·Dᵢₙ·(1+R(Dᵢₙ)) (3),

L_{Dnew}=L_{100%}·D_{new}·(1+R(D_{new})) (4),

It is also known that LDnew is L100% multiplying Din, thus the following equality (5) can be derived from equation (3):

L_{Din}−L_{Dnew}=L_{100%}·Dᵢₙ·R(Dᵢₙ) (5).

Then adopt equation (3) and equation (4) in the left side of the equality (5) and simplify the equation, and the following equality (6) can be derived:

Dᵢₙ=D_{new}·(1+R(D_{new})) (6).

The linearly dimming circuit and the method for linearly dimming control in the present disclosure adopts equality (6) to derive Dnew for determining the output driving current. Thus the light-emitting device has the desired luminance LDnew which is L100% multiplying Din.

When R(Dnew) is small, the following function (7) can be derived from equation (6) for evaluating Dnew:

$$\begin{matrix}{D}_{new} = \frac{{D}_{in}}{1 + R ( {D}_{new} )} \\ \approx {D}_{in} \cdot ( 1 - R ( {D}_{new} ) ) .\end{matrix} \qquad ( 7 )$$

In a practical implementation, when Din is input, R(Dnew) is unknown and R(Din) can be derived from equation (2). However for the most part, R(Dnew) is pretty close to R(Din) for a normal light-emitting device. Considering when implementing the present disclosure with the most simplified hardware resource, R(Dnew) in equation (7) can be replaced with R(Din) which can be represented by equation (2). Then a quadratic function of equation (8) can be derived as followed:

D_{new}=K·Dᵢₙ²+(1−K)·Dᵢₙ (8).

Alternately, if a more accurate result is desired, one can plug equation (2) into equation (6). And a quadratic equation of Dnew can be derived as equation (9):

K·D_{new}²−(1+K)·D_{new}+Dᵢₙ=0 (9).

From equation (9), one can derive a function to represent Dnew as equation (10):

$${D}_{new} = \frac{1 + K - \sqrt{{( 1 + K )}^{2} - 4 \cdot K \cdot {D}_{in}}}{2 \cdot K} . \qquad ( 10 )$$

It is noted that equation (10) is one of the two solutions of the quadratic equation (9). The other solution of equation (9) is greater than 1 and is not a reasonable solution to represent Dnew. As a result it is obsolete.

Dnew represented by equation (10) is an accurate result. However a more complicated functional operation is required, which means more hardware resources and calculating time. In practical applications, the tradeoff between equation (8) and equation (10) can be made to optimize hardware resources and the required accuracy.

Equation (8) and equation (10) are derived from equation (2), that is, the curve of the luminance error percentage R vs. Din is approximated by a linear function and when Din is at 100%, the luminance error percentage R(100%) is 0%. Thus equation (8) and equation (10) are suitable for the applications with a pure PWM method or a pure DC method. However for a mixed method, the luminance error percentage R as shown in FIG. 3 is divided into 2 sections based on the luminance percentage threshold, which means 2 separated curves are required to approximate the luminance error percentage R. Define the luminance percentage threshold to be Dth. When Din is larger than Dth, the approximated function of the luminance error percentage is R1(Din). And when Din is smaller than Dth, the approximated function of the luminance error percentage is R2(Din). Then equation (11) and equation (12) can be adopted to represent the approximated equations, and also there is a relation represented by equation (13):

R1(Dᵢₙ)=(1−Dᵢₙ)·K₁ (11),

R2(Dᵢₙ)=(A−Dᵢₙ)·K₂ (12),

R1(Dₜₕ)=R2(Dₜₕ) (13),

wherein K1 is a first system constant which is an absolute value of a slope of the approximated function R1 (Din), K2 is a second system constant which is an absolute value of a slope of the approximated function R2(Din), and A is a coefficient fulfilling equation (13) and can be represented as equation (14):

$$A = ( 1 - \frac{{K}_{1}}{{K}_{2}} ) \cdot {D}_{th} + \frac{{K}_{1}}{{K}_{2}} . \qquad ( 14 )$$

From equation (11), a quadratic function representing Dnew and a quadratic equation of Dnew can be derived, like the way deriving equation (8) and equation (9), and can be represented as equation (15) and equation (16):

D_{new}=K₁·Dᵢₙ²+(1−K₁)·Dᵢₙ (15),

K₁·D_{new}²−(1+K₁)·D_{new}+Dᵢₙ=0 (16).

Also from equation (12), a quadratic function representing Dnew and a quadratic equation of Dnew can be derived, like the way deriving equation (8) and equation (9), and can be represented as equation (17) and equation (18):

D_{new}=K₂·Dᵢₙ²+(1−K₃)·Dᵢₙ (17),

K₂·D_{new}²−(1+K₃)·D_{new}+Dᵢₙ=0 (18),

wherein K3 is a third system constant which is A multiplying K2.

Alternatively, because the luminance error percentage caused by the PWM method is much smaller than that caused by the DC method, when Din is smaller than Dth the luminance error percentage can be approximated as a constant and represented as the following equation:

R(Dᵢₙ)=K₄ (19),

wherein K4 is a fourth system constant fulfilling equation (13), that is, the approximated curve of the luminance error percentage R with mixed method should be continuous at Dth. As a result from equation (11), equation (13) and equation (19), one can derive K4=(1−Dth)*K1. Then plug equation (19) into equation (6) and a linear function representing Dnew can be derived as equation (20) shown:

$${D}_{new} = \frac{1}{1 + {K}_{4}} \cdot {D}_{in} . \qquad ( 20 )$$

It is noted that the characteristics of a light-emitting device is represented by the equation (2), equation (11), equation (12) and/or equation (19), and since the constants K, K1, K2, K3(that is A multiplying K2) and K4 can be stored by registers with specific bit numbers in a system, when various kinds of light-emitting devices are implemented in different applications, the constants K, K1, K2, K3 and K4 can be adjusted to characterize the adopted light-emitting device. For example define constant K=10*M/4095 wherein M is a 4-bit digital value stored in a register; effectively M equals one of integers from 0 to 15, that is, 16 choices. And when some kind of light-emitting device is adopted, an optimized choice of M is determined to represent the light-emitting device. The choice of M can also be determined device by device according to the different conditions when applying individual light-emitting device on individual application board. Even the aging condition of a specific light-emitting device can be traced and adjust the constant values accordingly. Thus the flexibility of the present disclosure on different applications is largely increased compared to the prior arts.

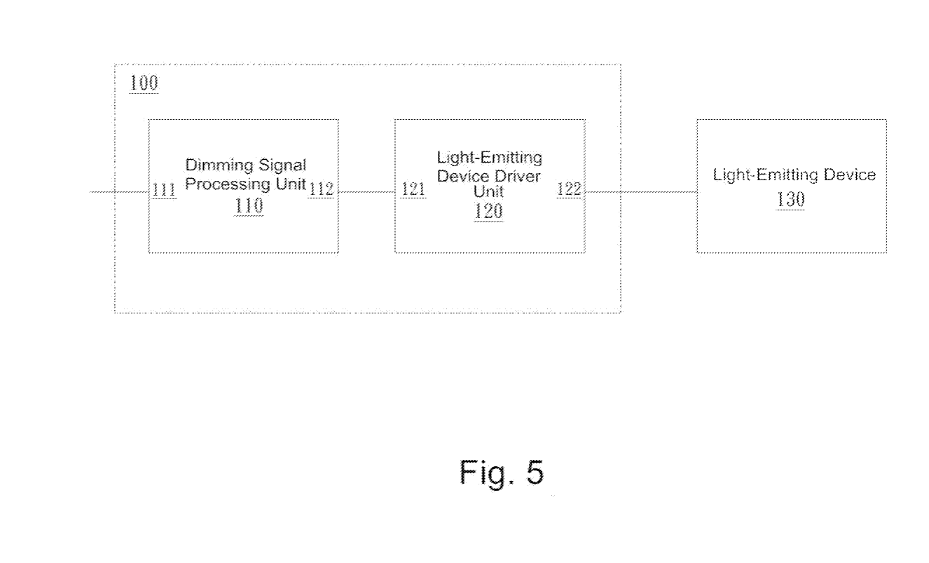

FIG. 5 is a block diagram of a linearly dimming circuit 100 of a light-emitting device of the present disclosure, which is adopted to output a driving current to drive the light-emitting device 130. The linearly dimming circuit 100 includes a dimming signal processing unit 110 and a light-emitting device driver stage 120. The dimming signal processing unit 110 has a dimming signal input terminal 111 and a current setting output terminal 112 wherein the dimming signal input terminal 111 receives a luminance percentage setting, which is the aforementioned Din, to set a luminance of the light-emitting device 130 to be a maximal luminance multiplying the luminance percentage setting Din. The dimming signal processing unit 110 generates a current percentage setting, which is the aforementioned Dnew, according to the luminance percentage setting Din. The current setting output terminal 112 outputs a driving current setting which sets the driving current to be a maximal driving current multiplying the current percentage setting Dnew.

The light-emitting device driver stage 120 has a current setting input terminal 121 and a driving current output terminal 122. The current setting input terminal 121 couples to the current setting output terminal 112 and receives the driving current setting. The driving current output terminal 122 outputs the driving current to the light-emitting device 130.

In more detail, when the luminance percentage setting Din is larger than a luminance percentage threshold, the current percentage setting Dnew is either a quadratic function of the luminance percentage setting Din, or a solution of a quadratic equation wherein the constant term is the luminance percentage setting Din. The following four embodiments are described to illustrate the linearly dimming circuit of the light-emitting device of the present disclosure.

In a first embodiment, the linearly dimming circuit 100 outputs the driving current with the PWM method or the pure DC method. The luminance error percentage R can be approximated by equation (2), and the quadratic function of equation (8) is adopted to represent the relation between the current percentage setting Dnew and the luminance percentage setting Din to attain some degree of compensation to light-emitting device with the most simplified hardware resources. In other words, when inputting a luminance percentage setting Din, the dimming signal processing unit 110 generates according to equation (8) a corresponding current percentage setting Dnew to set a driving current setting for outputting a corresponding driving current to drive the light-emitting device 130.

In a second embodiment, the linearly dimming circuit 100 outputs the driving current with the mixed method wherein a luminance percentage threshold Dth is determined. When Din is larger than Dth, the linearly dimming circuit 100 outputs the driving current with the DC method, and the luminance error percentage R can be approximated by equation (11), and the quadratic function of equation (15) is adopted to represent the relation between the current percentage setting Dnew and the luminance percentage setting Din to attain some degree of compensation to light-emitting device with the most simplified hardware resources. And when Din is smaller than Dth, the linearly dimming circuit 100 outputs the driving current with the PWM method, and the luminance error percentage R can be approximated by equation (11) or equation (19), and the quadratic function of equation (17) or the linear function of equation (20) is adopted to represent the relation between the current percentage setting Dnew and the luminance percentage setting Din to attain some degree of compensation to light-emitting device with the most simplified hardware resources. In other words, when inputting a luminance percentage setting Din, the dimming signal processing unit 110 generates according to equation (15) and equation (17) or (20) a corresponding current percentage setting Dnew to set a driving current setting for outputting a corresponding driving current to drive the light-emitting device 130.

In a third embodiment, the linearly dimming circuit 100 outputs the driving current with the PWM method or the pure DC method. The luminance error percentage R can be approximated by equation (2), and the quadratic equation of equation (9) is adopted to represent the relation between the current percentage setting Dnew and the luminance percentage setting Din to attain a more accurate compensation to light-emitting device. In other words, when inputting a luminance percentage setting Din, the dimming signal processing unit 110 generates according to equation (9) a corresponding current percentage setting Dnew to set a driving current setting for outputting a corresponding driving current to drive the light-emitting device 130.

In a fourth embodiment, the linearly dimming circuit 100 outputs the driving current with the mixed method wherein a luminance percentage threshold Dth is determined. When Din is larger than Dth, the linearly dimming circuit 100 outputs the driving current with the DC method, and the luminance error percentage R can be approximated by equation (11), and the quadratic equation of equation (16) is adopted to represent the relation between the current percentage setting Dnew and the luminance percentage setting Din to attain a more accurate compensation to light-emitting device. And when Din is smaller than Dth, the linearly dimming circuit 100 outputs the driving current with the PWM method, and the luminance error percentage R can be approximated by equation (12) or equation (19), and the quadratic equation of equation (18) or the linear function of equation (20) is adopted to represent the relation between the current percentage setting Dnew and the luminance percentage setting Din to attain a more accurate compensation to light-emitting device. In other words, when inputting a luminance percentage setting Din, the dimming signal processing unit 110 generates according to equation (16) and equation (18) or (20) a corresponding current percentage setting Dnew to set a driving current setting for outputting a corresponding driving current to drive the light-emitting device 130.

It is noted that the aforementioned four embodiments are described herein for the illustration purpose but not to limit the scope of the present disclosure. People skilled in the art can implement the present disclosure according to the practical requirements on applications, cost considerations on design, and with improved components and elements introduced by the state-of-the-art technique.

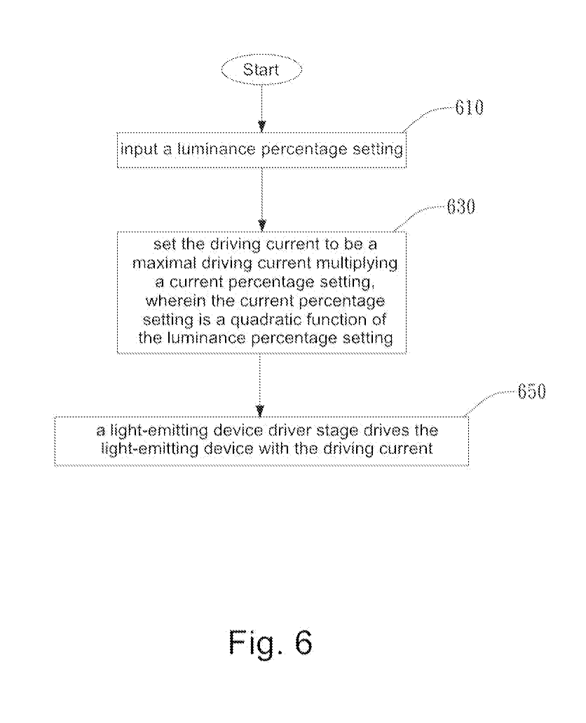

FIG. 6 is a flow chart of a first embodiment of a method for linearly dimming control of a light-emitting device of the present disclosure. The flow chart includes the following steps.

As shown in step 610, input a luminance percentage setting.

As shown in step 630, set the driving current to be a maximal driving current multiplying a current percentage setting wherein the current percentage setting is a quadratic function of the luminance percentage setting.

As shown in step 650, a light-emitting device driver stage drives the light-emitting device with the driving current.

Besides, in step 630 a specific quadratic function can be further included to represent the relation between the current percentage setting and the luminance percentage setting. Define the current percentage setting to be Dnew, the luminance percentage setting to be Din and a system constant K Thus the specific quadratic function can be represented as shown in equation (8).

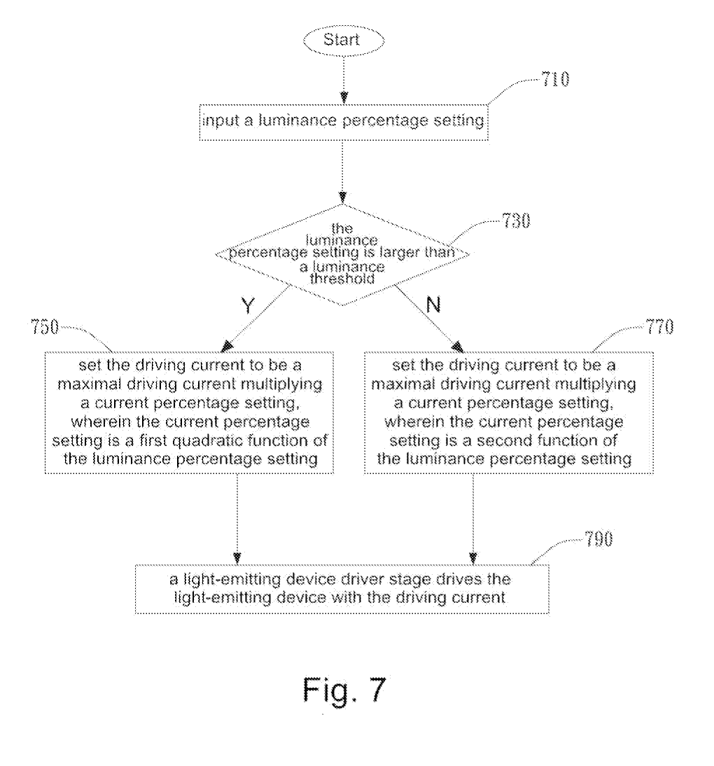

FIG. 7 is a flow chart of a second embodiment of a method for linearly dimming control of a light-emitting device of the present disclosure. The flow chart includes the following steps.

As shown in step 710, input a luminance percentage setting.

As shown in step 730, determine if the luminance percentage setting is larger than a luminance threshold. If the determination is yes, go to step 750. Otherwise go to step 770.

As shown in step 750, set the driving current to be a maximal driving current multiplying a current percentage setting wherein the current percentage setting is a first quadratic function of the luminance percentage setting.

As shown in step 770, set the driving current to be a maximal driving current multiplying a current percentage setting wherein the current percentage setting is a second function of the luminance percentage setting.

As shown in step 790, a light-emitting device driver stage drives the light-emitting device with the driving current.

Besides, in step 750, the first quadratic function can be further represented as shown in equation (15). In step 770, the second function can be further represented as shown in equation (17) or equation (20). Note that in the equations mentions in this paragraph, Dnew is the current percentage, Din is the luminance percentage setting, and K1, K2, K3 and K4 are the first, the second, the third and the fourth system constant respectively.

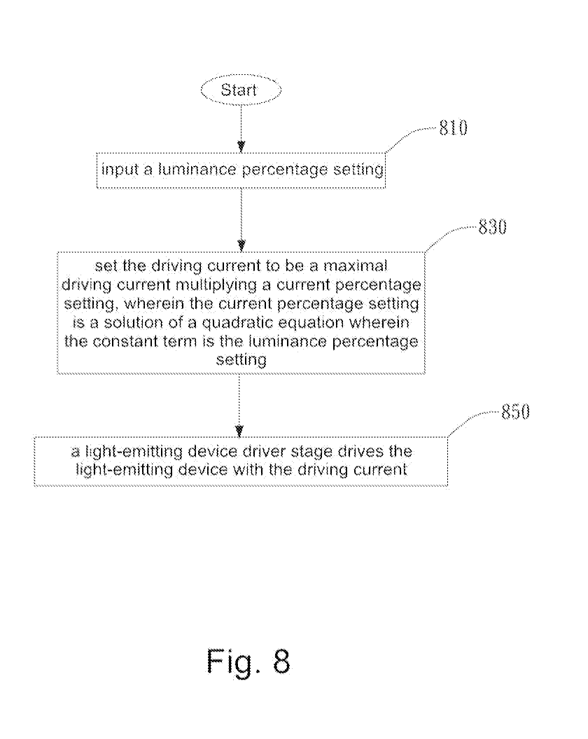

FIG. 8 is a flow chart of a third embodiment of a method for linearly dimming control of a light-emitting device of the present disclosure. The flow chart includes the following steps.

As shown in step 810, input a luminance percentage setting.

As shown in step 830, set the driving current to be a maximal driving current multiplying a current percentage setting wherein the current percentage setting is a solution of a quadratic equation wherein the constant term is the luminance percentage setting.

As shown in step 850, a light-emitting device driver stage drives the light-emitting device with the driving current.

Besides, in step 830 a specific quadratic equation can be further included to represent the relation between the current percentage setting and the luminance percentage setting. Define the current percentage setting to be Dnew, the luminance percentage setting to be Din and a system constant K Thus the specific quadratic equation can be represented as shown in equation (9).

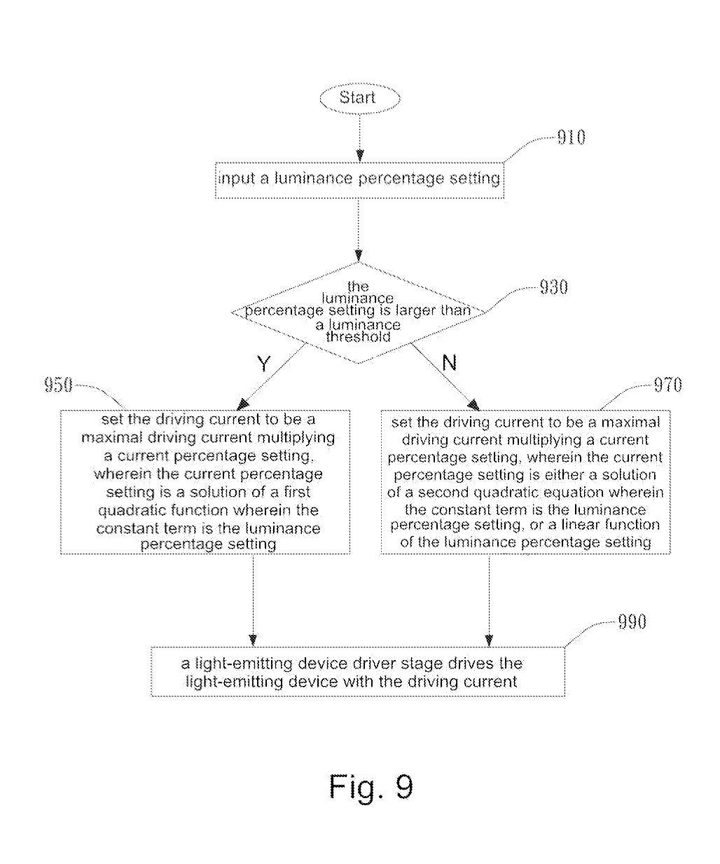

FIG. 9 is a flow chart of a fourth embodiment of a method for linearly dimming control of a light-emitting device of the present disclosure. The flow chart includes the following steps.

As shown in step 910, input a luminance percentage setting.

As shown in step 930, determine if the luminance percentage setting is larger than a luminance threshold. If the determination is yes, go to step 950. Otherwise go to step 970.

As shown in step 950, set the driving current to be a maximal driving current multiplying a current percentage setting wherein the current percentage setting is a solution of a first quadratic equation wherein the constant term is the luminance percentage setting.

As shown in step 970, set the driving current to be a maximal driving current multiplying a current percentage setting wherein the current percentage setting is either a solution of a second quadratic equation wherein the constant term is the luminance percentage setting, or a second function of the luminance percentage setting.

As shown in step 990, a light-emitting device driver stage drives the light-emitting device with the driving current.

Besides, in step 950, the first quadratic function can be further represented as shown in equation (16). In step 970, the second quadratic equation and the second function can be further represented as shown in equation (18) and equation (20) respectively. Note that in the equations mentions in this paragraph, Dnew is the current percentage, Din is the luminance percentage setting, and K1, K2, K3 and K4 are the first, the second, the third and the fourth system constant respectively.

This disclosure is advantageous because a simple function corresponding to the characteristics of a light-emitting device can be adopted to compensate the curve of the current percentage setting vs. the luminance percentage setting to derive the desired linear relation between the output luminance and the input control signal. And the coefficients of the mentioned simple function can all be adjusted flexibly such as by setting registers in a system. Thus the present disclosure has much flexibility on various applications.

The aforementioned descriptions represent merely the preferred embodiment of this disclosure, without any intention to limit the scope of this disclosure thereto. Various equivalent changes, alterations, or modifications based on the claims of this disclosure are all consequently viewed as being embraced by the scope of this disclosure.

What is claimed is:

1. A linearly dimming circuit of a light-emitting device, adapted to output a driving current to drive the light-emitting device, comprising:
a diming signal processing unit, having a dimming signal input terminal and a current setting output terminal, wherein the linearly dimming circuit is arranged such that the dimming signal input terminal receives a luminance percentage setting to set a luminance of the light-emitting device to be a maximal luminance multiplying the luminance percentage setting, and the dimming signal processing unit generates a current percentage setting according to the luminance percentage setting, the current setting output terminal outputs a driving current setting which sets the driving current to be a maximal driving current multiplying the current percentage setting; and
a light-emitting device driver stage, having a current setting input terminal and a driving current output terminal, wherein the current setting input terminal couples to the current setting output terminal and receives the driving current setting, and the driving current output terminal outputs the driving current to the light-emitting device;
wherein the linearly dimming circuit is arranged such that when the luminance percentage setting is larger than a luminance percentage threshold, the current percentage setting is either a quadratic function of the luminance percentage setting, or a solution of a quadratic equation wherein the constant term is the luminance percentage setting.

2. The linearly dimming circuit of the light-emitting device of claim 1, wherein the luminance percentage threshold is zero, and if the current percentage setting is Dnew, the luminance percentage setting is Din and a system constant is K, the quadratic function is represented as:
D_{new}=K·Dᵢₙ²+(1−K)·Dᵢₙ.

3. The linearly dimming circuit of the light-emitting device of claim 1, wherein if the current percentage setting is Dnew, the luminance percentage setting is Din, a first system constant is K1, a second system constant is K2, a third system constant is K3 and a fourth system constant is K4, when the luminance percentage setting is larger than the luminance percentage threshold, the quadratic function is a first quadratic function represented as:
D_{new}=K₁·Dᵢₙ²+(1−K₁)·Dᵢₙ;
and when the luminance percentage setting is smaller than the luminance percentage threshold, the current percentage setting is a second quadratic function of the luminance percentage setting represented as:
D_{new}=K₂·Dᵢₙ²+(1−K₃)·Dᵢₙ,
or the current percentage setting is a linear function of the luminance percentage setting represented as:
$${D}_{new} = \frac{1}{1 + {K}_{4}} \cdot {D}_{in} .$$

4. The linearly dimming circuit of the light-emitting device of claim 1, wherein the luminance percentage threshold is zero, and if the current percentage setting is Dnew, the luminance percentage setting is Din and a system constant is K, the quadratic function is represented as:
K·D_{new}²−(1+K)·D_{new}+Dᵢₙ=0.

5. The linearly dimming circuit of the light-emitting device of claim 1, wherein if the current percentage setting is Dnew, the luminance percentage setting is Din, a first system constant is K1, a second system constant is K2, a third system constant is K3 and a fourth system constant is K4, when the luminance percentage setting is larger than the luminance percentage threshold, the quadratic equation is a first quadratic equation represented as:
K₁·D_{new}²−(1+K₁)·D_{new}+Dᵢₙ=0;
and when the luminance percentage setting is smaller than the luminance percentage threshold, the current percentage setting is a solution of a second quadratic equation of the luminance percentage setting wherein the constant term is the luminance percentage setting, the second quadratic equation is represented as:
K₂·D_{new}²−(1+K₃)·D_{new}+Dᵢₙ=0;
or the current percentage setting is a linear function of the luminance percentage setting represented as:
$${D}_{new} = \frac{1}{1 + {K}_{4}} \cdot {D}_{in} .$$

6. A method for linearly dimming control of a light-emitting device, comprising the following steps:
inputting a luminance percentage setting;
setting the driving current to be a maximal driving current multiplying a current percentage setting, wherein the current percentage setting is a quadratic function of the luminance percentage setting; and
driving the light-emitting device through a light-emitting device driver stage with the driving current.

7. The method for linearly dimming control of the light-emitting device of claim 6, wherein if the current percentage setting is Dnew, the luminance percentage setting is Din and a system constant is K, the quadratic function is represented as:
D_{new}=K·Dᵢₙ²+(1−K)·Dᵢₙ.

8. The method for linearly dimming control of the light-emitting device of claim 6, wherein the step of setting the driving current further comprises:
determining if the luminance percentage setting is larger than a luminance threshold; if yes, the current percentage setting is a first quadratic function of the luminance percentage setting; if not, the current percentage setting is either a second quadratic function or a linear function of the luminance percentage setting.

9. The method for linearly dimming control of the light-emitting device of claim 8, wherein if the current percentage setting is Dnew, the luminance percentage setting is Din, a first system constant is K1, a second system constant is K2, a third system constant is K3 and a fourth system constant is K4, the first quadratic function is represented as:
D_{new}=K₁·Dᵢₙ²+(1−K₁)·Dᵢₙ;
the second quadratic function is represented as:
D_{new}=K₂·Dᵢₙ²+(1−K₃)·Dᵢₙ;
and the linear function is represented as:
$${D}_{new} = \frac{1}{1 + {K}_{4}} \cdot {D}_{in} .$$

10. A method for linearly dimming control of a light-emitting device, comprising the following steps:
inputting a luminance percentage setting;
setting the driving current to be a maximal driving current multiplying a current percentage setting, wherein the current percentage setting is a solution of a quadratic equation wherein the constant term is the luminance percentage setting; and
driving the light-emitting device through a light-emitting device driver stage with the driving current.

11. The method for linearly dimming control of the light-emitting device of claim 10, wherein if the current percentage setting is Dnew, the luminance percentage setting is Din and a system constant is K, the quadratic equation is represented as:
K·D_{new}²−(1+K)·D_{new}+Dᵢₙ=0.

12. The method for linearly dimming control of the light-emitting device of claim 10, wherein the step of setting the driving current further comprises:
determining if the luminance percentage setting is larger than a luminance threshold; if yes, the current percentage setting is a solution of a first quadratic equation wherein the constant term is the luminance percentage setting; if not, the current percentage setting is either a solution of a second quadratic equation wherein the constant term is the luminance percentage setting, or a linear function of the luminance percentage setting.

13. The method for linearly dimming control of the light-emitting device of claim 12, wherein if the current percentage setting is Dnew, the luminance percentage setting is Din, a first system constant is K1, a second system constant is K2, a third system constant is K3 and a fourth system constant is K4, the first quadratic equation is represented as:
K₁·D_{new}²−(1+K₁)·D_{new}+Dᵢₙ=0;
the second quadratic equation can be represented as:
K₂·D_{new}²−(1+K₃)·D_{new}+Dᵢₙ=0;
and the linear function can be represented as:
$${D}_{new} = \frac{1}{1 + {K}_{4}} \cdot {D}_{in} .$$
